(19) United States
(12) Patent Application Publication
(10) Pub. No.: US 2014/0274091 A1
(43) Pub. Date: Sep. 18, 2014

(54) PAGING FOR FLEXIBLE BANDWIDTH CARRIER SYSTEMS

(71) Applicant: QUALCOMM INCORPORATED, San Diego, CA (US)

(72) Inventors: Soumya DAS, San Diego, CA (US); Samir Salib SOLIMAN, Poway, CA (US); Edwin Chongwoo PARK, San Diego, CA (US)

(73) Assignee: QUALCOMM INCORPORATED, San Diego, CA (US)

(21) Appl. No.: 13/829,259

(22) Filed: Mar. 14, 2013

(51) Int. Cl. H04W 68/02

(52) U.S. Cl. CPC H04W 68/02
USPC 455/452.1; 455/458

(57) ABSTRACT

Methods, systems, and devices are provided that may support paging over a flexible bandwidth carrier. For example, a reduced paging capacity with respect to a target paging capacity for the flexible bandwidth carrier may be identified. The reduced paging capacity for the flexible bandwidth carrier may be mitigated by various techniques. One technique may include increasing a number of paging indicators sent per frame over the flexible bandwidth carrier. Other techniques may include reducing a Spreading Factor (SF) for a physical channel or a Secondary Common Control Physical Channel (SCCPCH) carrying the paging indicators over the flexible bandwidth carrier. Further techniques may include utilizing a plurality of paging channels, which may include utilizing a plurality of Paging Indicator Channels (PICHs) or a plurality of SCCPCHs. Other techniques may include reducing a paging area for at least the flexible bandwidth carrier and a normal bandwidth carrier.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, 3GPP Long Term Evolution (LTE) systems, and orthogonal frequency-division multiple access (OFDMA) systems.

Service providers are typically allocated blocks of frequency spectrum for exclusive use in certain geographic regions. These blocks of frequencies are generally assigned by regulators regardless of the multiple access technology being used. In most cases, these blocks are not integer multiple of channel bandwidths, hence there may be unutilized parts of the spectrum. As the use of wireless devices has increased, the demand for and value of this spectrum has generally surged, as well. Nonetheless, in some cases, wireless communications systems may not utilize portions of the allocated spectrum because the portions are not big enough to fit a standard or normal waveform. The developers of the LTE standard, for example, recognized the problem and decided to support many different system bandwidths (e.g., 1.4, 3, 5, 10, 15 and 20 MHz). This may provide one partial solution to the problem. Another approach to solve this problem may be to utilize flexible bandwidth carrier systems that may involve wireless communications systems that utilize portions of spectrum that may not fit a normal waveform. However, utilizing flexible bandwidth may have different impacts including dilating slot duration, frame duration, sub frame duration, radio frame duration, and/or Transmission Time Interval, which may impact data rates and may introduce delay. Time dilation in particular may cause broadcast channel and paging channel data rates to get scaled down compared to those for a normal system. Furthermore, fewer users may be supported by a flexible bandwidth carrier system as compared to a normal bandwidth carrier system for the same quality of service. In addition, a core network may be unaware of the flexible bandwidth carrier system and some user equipments may be serviced by a normal bandwidth carrier system while others by a flexible bandwidth carrier system. As a result, paging messages may be sent to UEs over both the normal and the flexible bandwidth carrier systems. Different impacts to paging capacity may thus result with regard to the flexible bandwidth carrier system.

### SUMMARY

Methods, systems, and devices are provided that can support paging over a flexible bandwidth carrier. These tools and techniques may address problems that may be introduced through the use of flexible bandwidth carrier systems with respect to paging, such as increased paging indicator channel (PICH) collision probability and/or reduced paging channel (PCH) capacity. In general, tools and techniques are thus provided to mitigate for these and other examples of reduced paging capacity for the flexible bandwidth carrier.

Flexible bandwidth carriers for wireless communications systems may utilize portions of spectrum that may not be big enough to fit a normal waveform utilizing flexible bandwidth waveforms. A flexible bandwidth system that utilizes a flexible bandwidth carrier may be generated with respect to a normal bandwidth system through dilating, or scaling down, the time or the chip rate of the flexible bandwidth system with respect to the normal bandwidth system. Some embodiments may increase the bandwidth of a waveform through expanding, or scaling up, the time or the chip rate of the flexible bandwidth system.

In some embodiments, mitigating for reduced paging capacity for a flexible bandwidth carrier may address the problem of increased PICH collision probability. This may be due to an increase in the number of user equipment to be paged in a time dilated frame, for example. If the number of paging indicators is kept the same for a flexible bandwidth carrier system with respect to a normal bandwidth carrier system, then the probability of PICH collision may increase. For the flexible bandwidth carrier system (e.g., one that may be employing time dilation), due to time dilation, the average number of UEs that may be paged in a frame may be increased by N (or Dcr) times, where Dcr may represent a chip rate divisor. This may result in a high probability of PICH collision, which may impact UE battery life, for example.

In some embodiments, mitigating a reduced paging capacity for a flexible bandwidth carrier involves utilizing a higher number of paging indicators per frame, such as for the PICH frame. The probability of collision may be kept approximately the same as for a normal bandwidth carrier system if the number of paging indicators per frame is scaled down by the bandwidth scaling factor N (or Dcr). With a larger number of paging indicators per frame, the number of repetitions may be less with respect to a normal bandwidth carrier system.

Another approach to mitigate a reduced paging capacity for a flexible bandwidth carrier may involve reducing a Spreading Factor (SF) for a physical channel carrying the paging indicators (e.g., PICH) over the flexible bandwidth carrier. For example, the SF for a PICH physical channel may be reduced by a factor up to the bandwidth scaling factor N (or Dcr) (e.g., SF=256 reduced to 256/N). In this case, the number of bits per paging indicator channel frame may be increased by N (or Dcr), which may result in the number of paging indicators per frame being maintained with respect to a normal bandwidth carrier system. In some cases, the SF may be reduced by N/2 (or other factor) instead of N. The power allocation to the paging indicator channel may be increased to compensate for the SF reduction or partly compensate for the reduction in SF. For example, where SF is reduced by 2, the power may be increased by around 50%.

In some instances, another option for mitigating a reduced paging capacity for a flexible bandwidth carrier may involve utilizing multiple paging indicators channels (e.g., multiple PICHs). In some cases, since each PICH may be associated with a secondary common control physical channel (SCCPCH), this option may involve utilizing multiple SCCPCHs. Overhead channels power allocation may be increased for such flexible bandwidth carrier systems utilizing multiple paging indicator channels.

In some embodiments, methods, systems, and devices provide for mitigating a reduced paging capacity that may result from a reduced paging channel capacity in particular. A paging area may be reduced when a Location Area (LA) and/or Routing Area (RA) may be shared between a normal bandwidth carrier system and a flexible bandwidth carrier system. This may help keep the paging load in the flexible bandwidth carrier system approximately the same as a normal bandwidth carrier system with a larger LA/RA, while the paging load for the normal bandwidth carrier may be lower.

In yet other embodiments, an approach for mitigating a reduced paging capacity may include utilizing separate LA/RAs for one or more flexible bandwidth carriers with respect to at least a normal bandwidth carrier or another flexible bandwidth carrier. The paging load may be made closer to that in a normal bandwidth carrier system for the flexible bandwidth carrier system. Separate LA/RAs may also be utilized based on the bandwidth scaling factor or groups of bandwidth scaling factors. In some cases, LA/RA may be shared between carriers with different scaling factors, such as N=1 and N=2, while another carrier, such as one with N=4, may have a separate LA/RA.

Some embodiments may include mitigating a reduced paging capacity for a flexible bandwidth carrier by utilizing multiple paging channels (e.g., multiple PCHs). Since each PCH may be mapped to a secondary common control physical channel (SCCPCH), this option may involve utilizing multiple SCCPCHs. The number of SCCPCHs utilized may depend upon the bandwidth scaling factor for the flexible bandwidth carrier. Overhead channels power allocation may be increased for such flexible bandwidth carrier systems utilizing multiple paging channels.

In some embodiments, mitigating a reduced paging capacity for a flexible bandwidth carrier with respect to a paging channel may involve reducing a SF for the paging channel. The SF for a PCH may be reduced by the bandwidth scaling factor N (or Dcr) (e.g., SF=128 reduced to 128/N). In some cases, the SF may be reduced by N/2 (or another factor besides 2) instead of N. The power allocation to the SCCPCH may be increased to compensate or partly compensate for the SF reduction. In some cases, the number of paging indicator channels may not need to be increased.

In instances where a core network may be aware of the flexible bandwidth carrier system, separate registration for the flexible bandwidth carrier system may be supported. This may also provide a way to mitigate a reduced paging capacity for a flexible bandwidth carrier.

Some embodiments include a method for supporting paging over a flexible bandwidth carrier. The method may include identifying a reduced paging capacity with respect to a target paging capacity for the flexible bandwidth carrier; and/or mitigating for the reduced paging capacity for the flexible bandwidth carrier.

In some embodiments, mitigating for the reduced paging capacity for the flexible bandwidth carrier includes increasing a number of paging indicators per frame over the flexible bandwidth carrier to mitigate for the reduced paging capacity for the flexible bandwidth carrier. Mitigating for the reduced paging capacity for the flexible bandwidth carrier may include reducing a spreading factor for a physical channel carrying one or more paging indicators over the flexible bandwidth carrier to mitigate for the reduced paging capacity for the flexible bandwidth carrier. Reducing the spreading factor may include reducing the spreading factor for the physical channel by at least a bandwidth scaling factor of the flexible bandwidth carrier or a fraction of the bandwidth scaling factor of the flexible bandwidth carrier. For example, for a bandwidth scaling factor equal N, the spreading factor could be reduced by N in some cases or by a fraction of N, such as N/2, in other cases. Some embodiments increasing a transmission power for the physical channel over the flexible bandwidth carrier with respect to a normal bandwidth carrier system having a same power spectrum density.

In some embodiments, mitigating for the reduced paging capacity for the flexible bandwidth carrier includes reducing a spreading factor for a secondary common control physical channel (SCCPCH) carrying one or more paging indicators over the flexible bandwidth carrier to mitigate for the reduced paging capacity for the flexible bandwidth carrier. Reducing the spreading factor may include reducing the spreading factor for the physical channel by at least a bandwidth scaling factor of the flexible bandwidth carrier or a fraction of the bandwidth scaling factor of the flexible bandwidth carrier. For example, for a bandwidth scaling factor equal N, the spreading factor could be reduced by N in some cases or by a fraction of N, such as N/2, in other cases. Some embodiments include increasing a transmission power for the SCCPCH over the flexible bandwidth carrier with respect to a normal bandwidth carrier system having a same power spectrum density.

In some embodiments, mitigating for the reduced paging capacity for the flexible bandwidth carrier includes utilizing a plurality of paging channels to mitigate for the reduced paging capacity for the flexible bandwidth carrier. The plurality of paging channels may include at least a plurality of PICHs or a plurality of SCCPCHs.

In some embodiments, mitigating for the reduced paging capacity for the flexible bandwidth carrier reducing a paging area. The paging area may be for at least the flexible bandwidth carrier and a normal bandwidth carrier.

In some embodiments, mitigating for the reduced paging capacity for the flexible bandwidth carrier includes utilizing at least a separate Location Area (LA) or a separate Routing Area (RA) for the flexible bandwidth carrier with respect to at least a normal bandwidth carrier or another flexible bandwidth carrier. Mitigating for the reduced paging capacity for the flexible bandwidth carrier may include registering at least one of the flexible bandwidth carriers separately at a core network.

In some embodiments, the target paging capacity includes a paging capacity of a normal bandwidth carrier system. The target paging capacity may include a paging capacity of another flexible bandwidth carrier in some cases.

Some embodiments include a wireless communications system for supporting paging over a flexible bandwidth carrier. The system may include: means for identifying a reduced paging capacity with respect to a target paging capacity for the flexible bandwidth carrier; and/or means for mitigating for the reduced paging capacity for the flexible bandwidth carrier.

The means for mitigating for the reduced paging capacity for the flexible bandwidth carrier may include means for increasing a number of paging indicators per frame over the flexible bandwidth carrier to mitigate for the reduced paging capacity for the flexible bandwidth carrier. The means for mitigating for the reduced paging capacity for the flexible bandwidth carrier may include means for reducing a spreading factor for a physical channel carrying one or more paging indicators over the flexible bandwidth carrier to mitigate for the reduced paging capacity for the flexible bandwidth carrier. Reducing the spreading factor may include reducing the spreading factor for the physical channel by at least a bandwidth scaling factor of the flexible bandwidth carrier or a fraction of the bandwidth scaling factor of the flexible bandwidth carrier. The means for mitigating for the reduced paging capacity for the flexible bandwidth carrier may include means for increasing a transmission power for the physical channel over the flexible bandwidth carrier with respect to a normal bandwidth carrier system having a same power spectrum density.

The means for mitigating for the reduced paging capacity for the flexible bandwidth carrier may include means for reducing a spreading factor for a secondary common control physical channel (SCCPCH) carrying one or more paging indicators over the flexible bandwidth carrier to mitigate for the reduced paging capacity for the flexible bandwidth carrier. Some embodiments include means for increasing a transmission power for the SCCPCH over the flexible bandwidth carrier with respect to a normal bandwidth carrier system having a same power spectrum density.

The means for mitigating for the reduced paging capacity for the flexible bandwidth carrier may include means for utilizing a plurality of paging channels to mitigate for the reduced paging capacity for the flexible bandwidth carrier. The plurality of paging channels may include at least a plurality of PICHs or a plurality of SCCPCHs.

The means for mitigating for the reduced paging capacity for the flexible bandwidth carrier may include means for reducing a paging area. The paging area may be for at least the flexible bandwidth carrier and a normal bandwidth carrier.

The means for mitigating for the reduced paging capacity for the flexible bandwidth carrier may include means for utilizing at least a separate Location Area (LA) or a separate Routing Area (RA) for the flexible bandwidth carrier with respect to at least a normal bandwidth carrier or another flexible bandwidth carrier. The means for mitigating for the reduced paging capacity for the flexible bandwidth carrier may include means for registering at least one of the flexible bandwidth carriers separately at a core network.

In some embodiments, the target paging capacity includes a paging capacity of a normal bandwidth carrier system. The target paging capacity may include a paging capacity of another flexible bandwidth carrier in some cases.

Some embodiments include computer program product for supporting paging over a flexible bandwidth carrier that may include a non-transitory computer-readable medium that may include: code for identifying a reduced paging capacity with respect to a target paging capacity for the flexible bandwidth carrier; and/or code for mitigating for the reduced paging capacity for the flexible bandwidth carrier.

In some embodiments, the code for mitigating for the reduced paging capacity for the flexible bandwidth carrier includes code for increasing a number of paging indicators per frame over the flexible bandwidth carrier to mitigate for the reduced paging capacity for the flexible bandwidth carrier. The code for mitigating for the reduced paging capacity for the flexible bandwidth carrier may include code for reducing a spreading factor for a physical channel carrying one or more paging indicators over the flexible bandwidth carrier to mitigate for the reduced paging capacity for the flexible bandwidth carrier.

The code for reducing the spreading factor may include code for reducing the spreading factor for the physical channel by at least a bandwidth scaling factor of the flexible bandwidth carrier or a fraction of the bandwidth scaling factor of the flexible bandwidth carrier. Some embodiments include code for increasing a transmission power for the physical channel over the flexible bandwidth carrier with respect to a normal bandwidth carrier system having a same power spectrum density.

The code for mitigating for the reduced paging capacity for the flexible bandwidth carrier may include code for reducing a spreading factor for a secondary common control physical channel (SCCPCH) carrying one or more paging indicators over the flexible bandwidth carrier to mitigate for the reduced paging capacity for the flexible bandwidth carrier. Some embodiments include code for increasing a transmission power for the SCCPCH over the flexible bandwidth carrier with respect to a normal bandwidth carrier system having a same power spectrum density.

The code for mitigating for the reduced paging capacity for the flexible bandwidth carrier may include code for utilizing a plurality of paging channels to mitigate for the reduced paging capacity for the flexible bandwidth carrier. The plurality of paging channels may include at least a plurality of PICHs or a plurality of SCCPCHs.

The code for mitigating for the reduced paging capacity for the flexible bandwidth carrier may include code for reducing a paging area. The paging area may be for at least the flexible bandwidth carrier and a normal bandwidth carrier.

The code for mitigating for the reduced paging capacity for the flexible bandwidth carrier may include code for utilizing at least a separate Location Area (LA) or a separate Routing Area (RA) for the flexible bandwidth carrier with respect to at least a normal bandwidth carrier or another flexible bandwidth carrier. The code for mitigating for the reduced paging capacity for the flexible bandwidth carrier may include code for registering at least one of the flexible bandwidth carriers separately at a core network.

In some embodiments, the target paging capacity includes a paging capacity of a normal bandwidth carrier system. In some embodiments, the target paging capacity includes a paging capacity of another flexible bandwidth carrier.

Some embodiments include a wireless communications device configured for supporting paging over a flexible bandwidth carrier. The wireless communications device may include at least one processor that may be configured to: identify a reduced paging capacity with respect to a target paging capacity for the flexible bandwidth carrier; and/or mitigate for the reduced paging capacity for the flexible bandwidth carrier.

The at least one processor configured to mitigate for the reduced paging capacity for the flexible bandwidth carrier may be configured to increase a number of paging indicators per frame over the flexible bandwidth carrier to mitigate for the reduced paging capacity for the flexible bandwidth carrier. The at least one processor configured to mitigate for the reduced paging capacity for the flexible bandwidth carrier may be configured to reduce a spreading factor for a physical channel carrying one or more paging indicators over the flexible bandwidth carrier to mitigate for the reduced paging capacity for the flexible bandwidth carrier. Reducing the spreading factor may include reducing the spreading factor for the physical channel by at least a bandwidth scaling factor of the flexible bandwidth carrier or a fraction of the bandwidth scaling factor of the flexible bandwidth carrier. The at least one processor may be configured to increase a transmission power for the physical channel over the flexible bandwidth carrier with respect to a normal bandwidth carrier system having a same power spectrum density.

The at least one processor configured to mitigate for the reduced paging capacity for the flexible bandwidth carrier may be configured reduce a spreading factor for a secondary common control physical channel (SCCPCH) carrying one or more paging indicators over the flexible bandwidth carrier to mitigate for the reduced paging capacity for the flexible bandwidth carrier. The at least one processor may be configured to increase a transmission power for the SCCPCH over the flexible bandwidth carrier with respect to a normal bandwidth carrier system having a same power spectrum density.

The at least one processor configured to mitigate for the reduced paging capacity for the flexible bandwidth carrier may be configured to utilize a plurality of paging channels to mitigate for the reduced paging capacity for the flexible bandwidth carrier. The plurality of paging channels may include at least a plurality of PICHs or a plurality of SCCPCHs.

The at least one processor configured to mitigate for the reduced paging capacity for the flexible bandwidth carrier may be configured to reduce a paging area. The paging area is for at least the flexible bandwidth carrier and a normal bandwidth carrier.

The at least one processor configured to mitigate for the reduced paging capacity for the flexible bandwidth carrier may be configured to utilize at least a separate Location Area (LA) or a separate Routing Area (RA) for the flexible bandwidth carrier with respect to at least a normal bandwidth carrier or another flexible bandwidth carrier. The at least one processor configured to mitigate for the reduced paging capacity for the flexible bandwidth carrier may be register at least one of the flexible bandwidth carriers separately at a core network.

In some embodiments of the wireless communications device, the target paging capacity includes a paging capacity of a normal bandwidth carrier system. In some cases, the target paging capacity includes a paging capacity of another flexible bandwidth carrier.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2A shows an example of a wireless communications system where a flexible bandwidth waveform fits into a portion of spectrum not broad enough to fit a normal waveform in accordance with various embodiments;

FIG. 2B shows an example of a wireless communications system where a flexible bandwidth waveform fits into a portion of spectrum near an edge of a band in accordance with various embodiments;

FIG. 3 shows a block diagram of a wireless communications system in accordance with various embodiments;

FIG. 4A shows a block diagram of a device configured for providing flexible bandwidth carrier paging in accordance with various embodiments.

FIG. 4B shows a more detailed block diagram of a device configured for providing flexible bandwidth carrier paging in accordance with various embodiments.

FIG. 5 shows a block diagram of a wireless communications system configured for providing flexible bandwidth carrier paging that includes a core network (CN) communicably coupled to one or more radio access networks (RANs) and one or more user equipments in accordance with various embodiments.

FIG. 6 shows a block diagram of a wireless communications system configured for providing flexible bandwidth carrier paging that includes a radio access network (RAN) and one or more user equipments in accordance with various embodiments.

FIG. 7 shows a block diagram of a user equipment configured for providing flexible bandwidth carrier paging in accordance with various embodiments;

FIG. 8 shows a block diagram of a communications system configured for providing flexible bandwidth carrier paging for wireless communications systems in accordance with various embodiments;

FIG. 9A shows a flow diagram of a method for providing flexible bandwidth carrier paging within wireless communications systems in accordance with various embodiments;

FIG. 9B shows a flow diagram of a method for providing flexible bandwidth carrier paging within wireless communications systems in accordance with various embodiments;

FIG. 9C shows a flow diagram of a method for providing flexible bandwidth carrier paging within wireless communications systems in accordance with various embodiments.

### DETAILED DESCRIPTION

Methods, systems, and devices are provided that support paging over a flexible bandwidth carrier. These tools and techniques may address problems that may be introduced through the use of flexible bandwidth carrier systems with respect to paging, such as increased paging indicator channel (PICH) collision probability and/or reduced paging channel (PCH) capacity. In general, tools and techniques are thus provided to mitigate for these and other examples of reduced paging capacity for the flexible bandwidth carrier.

Flexible bandwidth carriers for wireless communications systems may utilize portions of spectrum that may not be big enough to fit a normal waveform utilizing flexible bandwidth waveforms. A flexible bandwidth system that utilizes a flexible bandwidth carrier may be generated with respect to a normal bandwidth system through dilating, or scaling down, the time or the chip rate of the flexible bandwidth system with respect to the normal bandwidth system. Some embodiments may increase the bandwidth of a waveform through expanding, or scaling up, the time or the chip rate of the flexible bandwidth system.

In some embodiments, mitigating for reduced paging capacity with respect to a target paging capacity for a flexible bandwidth carrier may address the problem of increased PICH collision probability. The target paging capacity, for example, may include a paging capacity for a normal bandwidth carrier system or another flexible bandwidth carrier. If the number of paging indicators is kept the same for a flexible bandwidth carrier system with respect to a normal bandwidth carrier system, then the probability of PICH collision may increase. For the flexible bandwidth carrier system, due to time dilation, the number of UEs that may be paged in a frame may be increased by N (or Dcr) times. This may result in a high probability of PICH collision, which may impact UE battery life, for example.

In some embodiments, mitigating a reduced paging capacity for a flexible bandwidth carrier may involve utilizing a higher number of paging indicators per frame, such as for the PICH frame. The probability of collision may be kept approximately the same as for a normal bandwidth carrier system if the number of paging indicators per frame is scaled by the bandwidth scaling factor N (or Dcr). With a larger number of paging indicators per frame, the number of repetitions may be less with respect to a normal bandwidth carrier system.

Another approach to mitigate a reduced paging capacity for a flexible bandwidth carrier may involve reducing a Spreading Factor (SF) for a physical channel carrying one or more paging indicators over the flexible bandwidth carrier. For example, the SF for a PICH physical channel may be reduced by the bandwidth scaling factor N (or Dcr) (e.g., SF=256 reduced to 256/N). In this case, the number of bits per paging indicator channel frame may be increased by N (or Dcr), which may result in the number of paging indicators per frame being maintained with respect to a normal bandwidth carrier system. The power allocation to the paging indicator channel may be increased to compensate for the SF reduction. In another example, the SF may be reduced by a fraction of the bandwidth scaling factor, such as by N/2.

In some instances, another option for mitigating a reduced paging capacity for a flexible bandwidth carrier may involve utilizing multiple paging indicators channels (e.g., multiple PICHs). In some cases, since each PICH may be associated with a secondary common control physical channel (SCCPCH), this option may involve utilizing multiple SCCPCHs. Overhead channels power allocation may be increased for such flexible bandwidth carrier systems utilizing multiple paging indicator channels.

In some embodiments, methods, systems, and devices provide for mitigating a reduced paging capacity that may result from a reduced paging channel capacity in particular. A paging area may be reduced when a Location Area (LA) and/or Routing Area (RA) may be shared between a normal bandwidth carrier system and a flexible bandwidth carrier system. This may help keep the paging load in the flexible bandwidth carrier system approximately the same as a normal bandwidth carrier system with a larger LA/RA, while the paging load for the normal bandwidth carrier may be lower.

In yet other embodiments, an approach for mitigating a reduced paging capacity may include utilizing separate LA and/or separate RA for one or more flexible bandwidth carriers with respect to at least a normal bandwidth carrier or another flexible bandwidth carrier. The paging load may be made closer to that in a normal bandwidth carrier system for the flexible bandwidth carrier system. Separate LA/RAs may also be utilized based on the bandwidth scaling factor or groups of bandwidth scaling factors.

Some embodiments may include mitigating a reduced paging capacity for a flexible bandwidth carrier by utilizing multiple paging channels (e.g., multiple PCHs). Since each PCH may be mapped to a secondary common control physical channel (SCCPCH), this option may involve utilizing multiple SCCPCHs. The number of SCCPCHs utilized may depend upon the bandwidth scaling factor for the flexible bandwidth carrier. Overhead channels power allocation may be increased for such flexible bandwidth carrier systems utilizing multiple paging channels.

In some embodiments, mitigating a reduced paging capacity for a flexible bandwidth carrier with respect to a paging channel may involve reducing a SF for the paging channel. The SF for a PCH may be reduced by the bandwidth scaling factor N (or Dcr) (e.g., SF=128 reduced to 128/N). The power allocation to the SCCPCH may be increased to compensate for the SF reduction. In some cases, the number of paging indicator channels may not need to be increased. The SF may also be reduced by a fraction of the bandwidth scaling factor in some cases.

In instances where a core network may be aware of the flexible bandwidth carrier system, separate registration for the flexible bandwidth carrier system may be supported. This may also provide a way to mitigate a reduced paging capacity for flexible bandwidth carrier systems.

Techniques described herein may be used for various wireless communications systems such as CDMA, TDMA, FDMA, OFDMA, SC-FDMA, Peer-to-Peer, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA or OFDM system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above, as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Referring first to FIG. 1, a block diagram illustrates an example of a wireless communications system 100 in accordance with various embodiments. The system 100 includes base stations 105, user equipment 115, a base station controller 120, and a core network 130 (the controller 120 may be integrated into the core network 130 in some embodiments; in some embodiments, controller 120 may be integrated into base stations 105). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, Time Division Multiple Access (TDMA) signal, Frequency Division Multiple Access (FDMA) signal, Orthogonal FDMA (OFDMA) signal, Single-Carrier FDMA (SC-FDMA) signal, etc. Each modulated signal may be sent on a different carrier and may carry control information (e.g., pilot signals), overhead information, data, etc. The system 100 may be a multi-carrier LTE network capable of efficiently allocating network resources.

The user equipment 115 may be any type of mobile station, user equipment, access terminal, subscriber unit, or user equipment. The user equipment 115 may include cellular phones and wireless communications devices, but may also include personal digital assistants (PDAs), smartphones, other handheld devices, netbooks, notebook computers, etc. Thus, the term user equipment should be interpreted broadly hereinafter, including the claims, to include any type of wireless or mobile communications device.

Throughout this application, some user equipment may be referred to as flexible bandwidth capable user equipment, flexible bandwidth compatible user equipment, and/or flexible bandwidth user equipment. This may generally mean that the user equipment is flexible capable or compatible. In general, these devices may also be capable of normal functionality with respect to one or more normal radio access technologies (RATs). The use of the term flexible as meaning flexible capable or flexible compatible may generally be applicable to other aspects of system 100, such as for controller 120 and/or base stations 105, or a radio access network.

The base stations 105 may wirelessly communicate with the user equipment 115 via a base station antenna. The base stations 105 may be configured to communicate with the user equipment 115 under the control of the controller 120 via multiple carriers. Each of the base station 105 sites can provide communication coverage for a respective geographic area. In some embodiments, base stations 105 may be referred to as a NodeB, eNodeB, Home NodeB, and/or Home eNodeB. The coverage area for each base station 105 here is identified as 110-a, 110-b, or 110-c. The coverage area for a base station may be divided into sectors (not shown, but making up only a portion of the coverage area). The system 100 may include base stations 105 of different types (e.g., macro, micro, femto, and/or pico base stations).

The different aspects of system 100, such as the user equipment 115, the base stations 105, the core network 130, and/or the controller 120 may be configured to utilize flexible bandwidth and waveforms in accordance with various embodiments. System 100, for example, shows transmissions 125 between user equipment 115 and base stations 105. The transmissions 125 may include uplink and/or reverse link transmission, from a user equipment 115 to a base station 105, and/or downlink and/or forward link transmissions, from a base station 105 to a user equipment 115. The transmissions 125 may include flexible and/or normal waveforms. Normal waveforms may be referred to as legacy and/or normal waveforms.

The different aspects of system 100, such as the user equipment 115, the base stations 105, the core network 130, and/or the controller 120 may be configured to utilize flexible bandwidth and waveforms in accordance with various embodiments. For example, different aspects of system 100 may utilize portions of spectrum that may not be big enough to fit a normal waveform. Devices such as the user equipment 115, the base stations 105, the core network 130, and/or the controller 120 may be configured to adapt the chip rates, Spreading Factor (SF), and/or scaling factors to generate and/or utilize flexible bandwidth and/or waveforms. Some aspects of system 100 may form a flexible subsystem (such as certain user equipment 115 and/or base stations 105) that may be generated with respect to a normal subsystem (that may be implemented using other user equipment 115 and/or base stations 105) through dilating, or scaling down, the time of the flexible subsystem with respect to the time of the normal subsystem.

In some embodiments, different aspects of system 100, such as the user equipment 115, the base stations 105, the core network 130, and/or the controller 120 may be configured for supporting paging over a flexible bandwidth carrier, and particularly configured for mitigating increased paging indicator channel (PICH) collision probability and/or reduced paging channel (PCH) capacity by identifying a reduced paging capacity for the flexible bandwidth carrier; and mitigating for the reduced paging capacity for the flexible bandwidth carrier. These mitigation techniques will be described in further detail with reference to FIG. 3-7 below.

FIG. 2A shows an example of a wireless communications system 200-a with a base station 105-a and a user equipment 115-a in accordance with various embodiments, where a flexible bandwidth waveform 210-a fits into a portion of spectrum not broad enough to fit a normal waveform 220-a. System 200-a may be an example of system 100 of FIG. 1. In some embodiments, the flexible bandwidth waveform 210-a may overlap with the normal waveform 220-a that either the base 105-a and/or the user equipment 115-a may transmit. In some cases, the normal waveform 220-a may completely overlap the flexible bandwidth waveform 210-a. Some embodiments may also utilize multiple flexible bandwidth waveforms 210. In some embodiments, another base station and/or user equipment (not shown) may transmit one or more normal waveforms 220-a and/or the flexible bandwidth waveform 210-a.

FIG. 2B shows an example of a wireless communications system 200-b with a base station 105-b and user equipment 115-b, where a flexible bandwidth waveform 210-b fits into a portion of spectrum near an edge of a band, which may be a guard band, where normal waveform 220-b may not fit. System 200-b may be an example of system 100 of FIG. 1. User equipment 115-a/115-b and/or base stations 105-a/105-b may be configured to dynamically adjust the bandwidth of the flexible bandwidth waveforms 210-a/210-b in accordance with various embodiments.

In some embodiments, different aspects of systems 200-a and/or 200-b, such as the user equipment 115-a and/or 1150-b and/or the base stations 105-a and/or 105-b may be configured for reducing paging indicator channel (PICH) collision probability and/or for mitigating reduced paging channel (PCH) capacity due to the effects of time dilation of one or more flexible bandwidth carriers.

In general, a first waveform or carrier bandwidth and a second waveform or carrier bandwidth may partially overlap when they overlap by at least 1%, 2%, and/or 5%. In some embodiments, partial overlap may occur when the overlap is at least 10%. In some embodiments, the partial overlap may be less than 99%, 98%, and/or 95%. In some embodiments, the overlap may be less than 90%. In some cases, a flexible bandwidth waveform or carrier bandwidth may be contained completely within another waveform or carrier bandwidth. This overlap may still reflect partial overlap, as the two waveforms or carrier bandwidths do not completely coincide. In general, partial overlap can mean that the two or more waveforms or carrier bandwidths do not completely coincide (i.e., the carrier bandwidths are not the same).

Some embodiments may utilize different definitions of overlap based on power spectrum density (PSD). For example, one definition of overlap based on PSD is shown in the following overlap equation for a first carrier:

$$overlap = 100 \% * \frac{{\int }_{0}^{∞} {PSD}_{1} ( f ) * {PSD}_{2} ( f )}{{\int }_{0}^{∞} {PSD}_{1} ( f ) * {PSD}_{1} ( f )} .$$

In this equation, PSD₁(f) is the PSD for a first waveform or carrier bandwidth and PSD₂(f) is the PSD for a second waveform or carrier bandwidth. When the two waveforms or carrier bandwidths coincide, then the overlap equation may equal 100%. When the first waveform or carrier bandwidth and the second waveform or carrier bandwidth at least partially overlap, then the overlap equation may not equal 100%. For example, the Overlap Equation may result in a partial overlap of greater than or equal to 1%, 2%, 5%, and/or 10% in some embodiments. The overlap equation may result in a partial overlap of less than or equal to 99%, 98%, 95%, and/or 90% in some embodiments. One may note that in the case in which the first waveform or carrier bandwidth is a normal waveform or carrier bandwidth and the second waveform or a carrier waveform is a flexible bandwidth waveform or carrier bandwidth that is contained within the normal bandwidth or carrier bandwidth, then the overlap equation may represent the ratio of the flexible bandwidth compared to the normal bandwidth, represented as a percentage. Furthermore, the overlap equation may depend on which carrier bandwidth's perspective the overlap equation is formulated with respect to. Some embodiments may utilize other definitions of overlap. In some cases, another overlap may be defined utilizing a square root operation such as the following:

$$overlap = 100 \% * \sqrt{\frac{{\int }_{0}^{∞} {PSD}_{1} ( f ) * {PSD}_{2} ( f )}{{\int }_{0}^{∞} {PSD}_{1} ( f ) * {PSD}_{1} ( f )}} .$$

Other embodiments may utilize other overlap equations that may account for multiple overlapping carriers.

FIG. 3 shows a wireless communications system 300 with core network 130-a, one or more controllers 120-a, a base station 105-c, user equipment 115-c and 115-d, in accordance with various embodiments. In some embodiments, controller 120-a, and base station 105-c may be at the same location or part of the same device, such as controller-base station 305. Different aspects of system 300-a, such as the core network 130-a, the base station 105-c, controller-base station 305, and/or the user equipment 115-c and/or 115-d, may be configured for improving the performance of paging over a flexible bandwidth carrier by identifying a reduced paging capacity for the flexible bandwidth carrier, and mitigating for the reduced paging capacity for the flexible bandwidth carrier.

Various aspects of system 300-a may be configured for mitigating for the reduced capacity of a flexible bandwidth carrier by employing one or more techniques for reducing PICH collisions and for mitigating for reduced paging capacity generally. PICH collision reduction techniques may include, for example, increasing a number of paging indicators per frame over the flexible bandwidth carrier. Various aspects of system 300-a may also be configured to reduce a Spreading Factor (SF) for a physical channel carrying the paging indicators over the flexible bandwidth carrier. This technique may also include increasing a transmission power for the physical channel over the flexible bandwidth carrier with respect to a normal bandwidth carrier system with a same or similar spectrum density.

Various aspects of system 300-a may also, or alternatively, be configured to reduce a SF for a secondary common control physical channel (SCCPCH) over the flexible bandwidth carrier. This technique may further include increasing a transmission power for the SCCPCH over the flexible bandwidth carrier with respect to a normal bandwidth carrier system with a same or similar spectrum density.

Various aspects of system 300-a may also, or alternatively, be configured for mitigating the reduced paging capacity for a flexible bandwidth carrier by utilizing a plurality of paging channels, which may include utilizing a plurality of PICHs or a plurality of SCCPCHs. Other mitigation techniques that may be employed by various aspects of system 300-a include reducing a paging area for at least a flexible bandwidth carrier and a normal bandwidth carrier; utilizing at least a separate Location Area (LA and Routing Area (RA) for a flexible bandwidth carrier with respect to at least a normal bandwidth carrier or another flexibly bandwidth carrier; and/or registering the flexible bandwidth carrier separately at a core network (CN).

These and other paging capacity reduction techniques will be described in further detail with respect to FIG. 4B below.

Transmissions 125-a and/or 125-b between the user equipment 115-c/115-d and the base station 105-c may utilize flexible bandwidth waveforms that may be generated to occupy less (or more) bandwidth than a normal waveform. For example, at a band edge, there may not be enough available spectrum to place a normal waveform. For a flexible bandwidth waveform, as time gets dilated, the frequency occupied by a waveform goes down, thus making it possible to fit a flexible bandwidth waveform into spectrum that may not be broad enough to fit a normal waveform. In some embodiments, the flexible bandwidth waveform may be scaled utilizing a scaling factor N with respect to a normal waveform. Scaling factor N may take on numerous different values including, but not limited to, integer values such as 1, 2, 3, 4, 8, etc. N, however, does not have to be an integer. Some embodiments may utilize a chip rate divisor (Dcr). In some cases, a Dcr may equal a scaling factor N for the flexible bandwidth carrier and/or system.

Some embodiments may utilize additional terminology. A new unit D may be utilized. The unit D is dilated. The unit is unitless and has the value of N. One can talk about time in the flexible system in terms of “dilated time”. For example, a slot of say 10 ms in normal time may be represented as 10 Dms in flexible time (note: even in normal time, this will hold true since N=1 in normal time: D has a value of 1, so 10 Dms=10 ms). In time scaling, one can replace most “seconds” with “dilated-seconds”. Note frequency in Hertz is 1/s.

As discussed above, a flexible bandwidth waveform may be a waveform that occupies less bandwidth than a normal waveform. Thus, in a flexible bandwidth system, the same number of symbols and bits may be transmitted over a longer duration compared to normal bandwidth system. This may result in time stretching, whereby slot duration, frame duration, etc., may increase by a scaling factor N. Scaling factor N may represent the ratio of the normal bandwidth to flexible bandwidth (BW). Thus, data rate in a flexible bandwidth system may equal (Normal Rater 1/N), and delay may equal (Normal Delay×N). In general, a flexible systems channel BW=channel BW of normal systems/N. Delay×BW may remain unchanged. Furthermore, in some embodiments, a flexible bandwidth waveform may be a waveform that occupies more bandwidth than a normal waveform.

Throughout this specification, the term normal system, subsystem, and/or waveform may be utilized to refer to systems, subsystems, and/or waveforms that involve embodiments that may utilize a scaling factor that may be equal to one (e.g., N=1) or a normal or standard chip rate. These normal systems, subsystems, and/or waveforms may also be referred to as standard and/or legacy systems, subsystems, and/or waveforms. Furthermore, flexible systems, subsystems, and/or waveforms may be utilized to refer to systems, subsystems, and/or waveforms that involve embodiments that may utilize a scaling factor that may be not equal to one (e.g., N=2, 4, 8, ½, ¼, etc.). For N>1, or if a chip rate is decreased, the bandwidth of a waveform may decrease. Some embodiments may utilize scaling factors or chip rates that increase the bandwidth. For example, if N<1, or if the chip rate is increased, then a waveform may be expanded to cover bandwidth larger than a normal waveform. Flexible systems, subsystems, and/or waveforms may also be referred to as fractional systems, subsystems, and/or waveforms in some cases. Fractional systems, subsystems, and/or waveforms may or may not change bandwidth, for example. A fractional system, subsystem, or waveform may be flexible because it may offer more possibilities than a normal or standard system, subsystem, or waveform (e.g., N=1 system). Furthermore, the use of the term flexible may also be utilized to mean flexible bandwidth capable.

Turning next to FIG. 4A, a block diagram illustrates a device 400-a configured for identifying a reduced paging capacity and mitigating for the reduced paging capacity for a flexible bandwidth carrier in accordance with various embodiments. The device 400-a may be an example of aspects of the base station 105 of FIGS. 1, 2A, 2B, 3, 6, and/or 8; UE 115, of FIGS. 1, 2A, 2B, 3, 5, 6, 7, and/or 8; CN 130 of FIGS. 1, 3, 5, and/or 6; RAN 550 of FIGS. 5 and/or 6; and/or controller 120 of FIGS. 1 and/or 3. The device 400-a may also be a processor. The device 400-a may include a receiver module 405, a flexible bandwidth (BW) paging module (paging module) 410, and/or a transmitter module 415. Each of these components may be in communication with each other.

These components of the device 400-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 405 may receive information such as packet, data, and/or signaling information regarding what device 400-a has received or transmitted. The received information may be utilized by the paging module 410 for a variety of purposes. The transmitter module 415 may further transmit information according to the processes performed by the paging module 410 on the received information or other information.

In some embodiments, the paging module 410 is configured for identifying a reduced paging capacity with respect to a target paging capacity for a flexible bandwidth carrier and mitigating for the reduced paging capacity for the flexible bandwidth carrier. Paging module 410 may be configured to perform one or more, or all of the reduced paging capacity mitigation techniques including both techniques to reduce PICH collisions and techniques to mitigate for reduced paging capacity generally as described in more detail with reference to FIG. 4B. The target paging capacity may include a paging capacity for a normal bandwidth carrier system or for another flexible bandwidth carrier, for example.

Turning next to FIG. 4B, a block diagram illustrates a device 400-b that includes reduced paging capacity mitigation functionality in accordance with various embodiments. The device 400-b may be an example of aspects of the base station 105 of FIGS. 1, 2A, 2B, 3, 6, and/or 8; UE 115 of FIGS. 1, 2A, 2B, 3, 5, 6, 7, and/or 8; CN 130 of FIGS. 1, 3, 5, and/or 6; RAN 550 of FIGS. 5 and/or 6; and/or controller 120 of FIGS. 1 and/or 3. The device 400-b may also be a processor. The device 400-b may include a receiver module 405-a, a flexible bandwidth paging module (paging module) 410-a, and/or a transmitter module 415-a. Each of these components may be in communication with each other. Paging module 410-a may further include one or more of a paging indicator/frame adjustor module 435, a physical channel spreading factor adjustor module 420, a secondary SCCPCH spreading factor adjustor module 425, a transmission power adjustor module 430, a paging channel adjustor module 440, a paging area reduction module 445, a LA and RA assignment module 450, and/or a carrier registration module 455. The functionality of these modules will be explained in greater detail below. It should be appreciated that the functionality of each of these modules may be combined with any other module, some functionality may be excluded, and the modules may be implemented in various ways without departing from the scope and spirit of this disclosure.

These components of the device 400-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 405-a may receive information such as packet, data, and/or signaling information regarding what device 400-b has received or transmitted. In some embodiments, different aspects of system 100, such as the user equipment 115, the base stations 105, the core network 130, and/or the controller 120 may be configured for mitigating the reduced paging capacity in a flexible bandwidth carrier system, as further detailed below.

In some embodiments, techniques for improving paging performance over a flexible bandwidth carrier may include techniques for reducing PICH collisions. PICH collision is generally related to PICH capacity. PICH capacity is dependent upon the number (Np) of paging indicators (PI) per frame and consequently on the number of PICH bits mapped to a single PI. A large Np may decrease the PICH collision probability. A PICH collision may be defined as the event when a UE that is not being paged wakes up because its assigned PI is shared with another UE, which is being paged in the current Paging Occasion. The collision may negatively affect the UE battery life. The probability of PICH collision can be calculated according to the following:

$${[ {P}_{c} ]}_{UMTS} = 1 - {( 1 - \frac{1}{{N}_{p}} )}^{m}$$

where m is the number of UEs paged in the frame.

For flexible bandwidth carrier systems, such as Fractional UMTS (F-UMTS), keeping Nₚ the same may increase the probability of PICH collision. For F-UMTS, due to time dilation, the number of UEs to be paged in a frame may be increased N (or Dcr) times. As a result, the probability of collision can be calculated as:

$${[ {P}_{c} ]}_{NF \text{-} UMTS} = 1 - {( 1 - \frac{1}{{N}_{p}} )}^{N * m}$$

The higher probability of PICH collision may also affect the UE battery life.

In some embodiments, these effects may be mitigated by the paging indicator/Frame adjustor module 435, which may increase a Nₚ per frame over the flexible bandwidth carrier to mitigate for the reduced paging capacity for the flexible bandwidth carrier. This technique may be represented by the following:

$${[ {N}_{p} ]}_{NF \text{-} UMTS} = N * {{[ {N}_{p} ]}_{UMTS} \\ [ {P}_{c} ]}_{NF \text{-} UMTS} = 1 - {( 1 - \frac{1}{{[ {N}_{p} ]}_{NF \text{-} UMTS}} )}^{N * m} = 1 - {( 1 - \frac{1}{N * {[ {N}_{p} ]}_{UMTS}} )}^{N * m}$$

Using first order approximation, [P_{c}]_{N F-UMTS} may equal [P_{c}]_{UMTS}. Hence the probability of collision may be kept almost the same if Nₚ is scaled by N (or Dcr) to N*Nₚ. A further result of this technique may be that with a larger Nₚ, the number of repetitions may also be reduced.

In some instances, the physical channel spreading factor adjustor module 420 may mitigate for increased PICH collisions by reducing the SF of PICH physical channel carrying the paging indicators over the flexible bandwidth carrier. In some embodiments, this reduction may be from 256 to 256/Dcr, i.e. to 256/N. The number of bits per PICH frame may be increased by Dcr (N), and the same Np as in a normal bandwidth carrier system, such as UMTS, can be maintained. This technique may also include increasing a transmission power, by for instance the transmission power adjustor module 430, for the physical channel over the flexible bandwidth carrier with respect to a normal bandwidth carrier system having a same power spectrum density.

Another option to mitigate for increase PICH collisions may include the paging channel adjustor module 440 utilizing a plurality of paging channels, which in turn may also mitigate for the reduced paging capacity for the flexible bandwidth carrier. In some embodiments, each PICH may be associated with a secondary common control physical channel (SCCPCH). This technique may also involve utilizing multiple SCCPCHs to support multiple paging channels. In some embodiments, this technique may include increasing by the transmission power adjustor module 430 a transmission power for the physical channel over the flexible bandwidth carrier with respect to a normal bandwidth carrier system having a same power spectrum density.

In some embodiments, techniques for improving paging performance over a flexible bandwidth carrier may include techniques for increasing paging capacity. In some instances, a paging bottle-neck may occur at the air interface. Thus, the PCH capacity of the individual cells may determine the paging capacity. In each discontinuous reception (DRX) Cycle, N paging occasions may be possible. In each paging occasion, Np number of paging indicators may indicate which UE should decode the next paging message on an SCCPCH, for example.

By way of illustration, if a DRX Cycle Length Coefficient is assumed to be 7, then a corresponding DRX interval may be 1.28 sec. As a result, there may be 128 frames and accordingly 128 paging occasions. Further assuming Np=18 and an even distribution of the UEs' International Mobile Subscriber Identities (IMSI), 18*128=2304 paging indications would be possible. In a flexible bandwidth carrier system, such as F-UMTS, the DRX interval may be computed as 1.28×Dcr sec for a DRX Cycle Length Coefficient of 7. This may indicate that there are 2304 paging indications in 1.28×Dcr sec or 2304/Dcr paging indications in 1.28 sec.

In some instances, the paging message may vary in size depending on whether International Mobile Subscriber Identity (IMSI), Temporary Mobile Subscriber Identity (TMSI) or P-TMSI is used for UE Identity. In some instances, IMSI is encoded in 72 bits while TMSI and P-TMSI are encoded in 40 bits. The logical channel generally used for paging is PCCH or PCCH Logical Channel, which may also be referred to as the Paging Control Channel. Based on IMSI, TMSI, or P-TMSI based paging, as is well known in the art, generally 300-500 pages per second can be supported. This may assume 1 SCCPCH, which is a typical configuration, though the standard allows for up to 16 SCCPCHs. This also may assume that UEs are equally distributed over the PIs. Accordingly, generally 3 IMSI-GSM-MAP paging messages can be supported by each 10 ms transmission time interval (TTI), and 5 TMSI-GSM-MA/P-TMSI-GSM-MAP paging messages can be supported by the same interval.

In some instances, as the TTI for SRB mapped to PCCH becomes 10×Dcr, maximum of 3 IMSI-GSM-MAP paging can be supported by each 10×Dcr ms TTI and maximum of 5 TMSI-GSM-MAP/P-TMSI-GSM-MAP paging can be supported by each 10×Dcr ms TTI. Therefore, 300/Dcr-500/Dcr pages per second can be supported. Therefore, 300/Dcr-500/Dcr pages per second may be supported. Alternatively, floor (300/Dcr)-floor (500/Dcr) pages per second may be supported. These calculations may assume the utilization of 1 SCCPCH which is typical configuration, though the standard allows up to 16 SCCPCHs. This also may assume that UEs are equally distributed over the PIs. This implies that the paging capacity of a flexible bandwidth carrier system, such as a Fractional UMTS system may be Dcr times less than the normal bandwidth carrier system, such as a UMTS system.

In some embodiments, techniques for mitigating for reduced paging capacity may include reducing a paging area, for instance by paging area reduction module 445, for at least the flexible bandwidth carrier and a normal bandwidth carrier. This technique may further include reducing the paging area. In some cases, this may be for both a flexible and normal bandwidth carrier when the Location Area (LA) and/or Routing Area (RA) is shared between a normal bandwidth carrier system and a flexible bandwidth carrier system, such as between a UMTS and an F-UMTS. This technique may maintain the same or similar paging load in a flexible bandwidth carrier system as in a normal bandwidth carrier system with bigger LA/RA, while the paging load of normal bandwidth carrier system would be even lower. This may result because in some instances, a large LA/RA may result in low signal loading but a high paging loading, while, a small LA/RA may result in a high signal loading but a low paging loading.

Another technique for mitigating reduced paging capacity may include utilizing, for instance by the LA and RA assignment module 450, separate (LA) and Routing Area (RA) for a flexible system. This may result in the paging load approximating that in a normal system. There may be fewer users in a flexible system, such as an F-UMTS system, but because the CN may not be aware of the flexible capacity of the flexible system, the CN may initiate and send paging messages for all UEs over the flexible system. Therefore, separate LA/RAs may result in less paging in the system overall. Increased registration signaling may be implemented if the UE(s) in the system move between normal and flexible systems.

Another technique for mitigating reduced paging capacity may include reducing the Spreading Factor (SF) for a SCCPCH, for example by SCCPSCH spreading factor adjustor module 425. Generally, the SF for a PCH is 128 in a normal bandwidth carrier system, such as UMTS. For a flexible bandwidth carrier system, such as an F-UMTS, the SF can be reduced to 128/Dcr for handling the same paging capacity at the same paging load. In some instances, this reduction in SF may further include increasing a transmission power for the SCCPCH, such as by transmission power adjustor module 430, over the flexible bandwidth carrier with respect to a normal bandwidth carrier system having a same power spectrum density. However, because the number of PICHs does not need to be increased with this technique, the overhead channel power allocation may only be slightly increased.

In some embodiments, Carrier Registration module 455 may mitigate for a reducing paging capacity by registering one or more flexible bandwidth carriers with the CN. This registration may be communicated to/from the CN, for example, by receiver module 405-a and/or transmitter module 415-a. This may allow the CN to coordinate paging transmissions to minimize un-needed redundancy and free up paging capacity by determining that a UE is currently being served by a flexible bandwidth carrier. This technique may also include increased signaling for separate registrations.

FIG. 5 shows a block diagram of a communications system 500 that may be configured for mitigating reduced paging capacity over one or more flexible bandwidth carriers in accordance with various embodiments. This system 500 may include aspects of the system 100 depicted in FIG. 1, system 200-a of FIG. 2A, system 200-b of FIG. 2B, system 300 of FIG. 3, device 400-a of FIG. 4A, device 400-b of FIG. 4B, and/or system 800 of FIG. 8. The core network 130-b may include memory 515, and a processor module 510, which each may be in communication, directly or indirectly, with each other (e.g., over one or more buses). In some cases, the core network 130-b may communicate with other aspects of the network communications module 505.

Core network 130-b may also communicate with radio access networks 550-a/550-b. Radio access networks 550 may be co-located in some cases, or separated located. In some cases, radio access networks 550 may include flexible capable radio access networks and/or normal/legacy radio access networks. Radio access networks 550 may be in wireless communication with user equipment 115-e, which may be flexible capable, and may also be in wireless communication with user equipment 115-f, which may be normal bandwidth capable. In some cases, core network 130-b may communicate with radio access networks 550 utilizing radio access network communication module 545.

The memory 515 may include random access memory (RAM) and read-only memory (ROM). The memory 515 may also store computer-readable, computer-executable software code 516 containing instructions that are configured to, when executed, cause the processor module 510 to perform various functions described herein (e.g., call processing, database management, message routing, etc.). Alternatively, the software 516 may not be directly executable by the processor module 510 but be configured to cause the computer, e.g., when compiled and executed, to perform functions described herein.

The processor module 510 may include an intelligent hardware device, e.g., a central processing unit (CPU) such as those made by Intel® Corporation or AMD®, a microcontroller, an application-specific integrated circuit (ASIC), etc. The processor module 510 may include a speech encoder (not shown) configured to receive audio via a microphone, convert the audio into packets (e.g., 20 ms in length) representative of the received audio, provide the audio packets, and provide indications of whether a user is speaking.

According to the architecture of FIG. 5, the core network 130-b may further include a communications management module 540. The communications management module 540 may manage communications other aspects of communication, such as communication with user equipment 115-e/115-f. By way of example, the communications management module 540 may be a component of the core network 130-b in communication with some or all of the other components of the core network 130-b via a bus. Alternatively, functionality of the communications management module 540 may be implemented as a component of the radio access network communications module 545, as a computer program product, and/or as one or more controller elements of the processor module 510.

The components for core network 130-b may be configured to implement aspects discussed above with respect to device 400-a and/or 400-b in FIGS. 4A and 4B and may not be repeated here for the sake of brevity. The flexible BW paging module 410-b (paging module) may be an example of the support for Paging modules 410 and 410-a of FIGS. 4A and 4B. Paging module 410-b may be configured for reducing PICH collisions and for mitigating for reduced paging capacity generally including the techniques described above in reference to FIG. 4B.

The core network 130-b may also include a handover module 535 that may be utilized to perform handover procedures of the user equipments 115 from one radio access network 550 to another. For example, the handover module 535 may perform a handover procedure of the user equipment 115-f from core network 130-b to another where normal waveforms are utilized between the user equipment 115-f and one of the radio access networks 550-b and flexible bandwidth waveforms are utilized between the user equipment 115-e and another radio access network 550-a. The core network 130-b may also include a registration module 530 for registering different user equipments 115 with different services (e.g., CS, PS) through different RANs 550.

FIG. 6 shows a block diagram of a communications system 600 that may be configured for mitigating reduced paging capacity over one or more flexible bandwidth carriers in accordance with various embodiments. This system 600 may include aspects of the system 100 depicted in FIG. 1, system 200-a of FIG. 2A, system 200-b of FIG. 2B, system 300 of FIG. 3, device 400-a of FIG. 4A, device 400-b of FIG. 4B, system 500 of FIG. 5, and/or system 800 of FIG. 8. The radio access network 550-c may include aspects of a base station 105 and/or a controller 120 to represent a combined system and/or separate components that may comprise part of a radio access network. The radio access network 550-c may include antennas 630, a transceiver module 625, memory 615, and a processor module 610, which each may be in communication, directly or indirectly, with each other (e.g., over one or more buses). The transceiver module 625 may be configured to communicate bi-directionally, via the antennas 630, with the user equipment 115-g, which may be a multi-mode user equipment. The transceiver module 625 (and/or other components of the radio access network 550-c) may also be configured to communicate bi-directionally with one or more networks. In some cases, the radio access network 550-c may communicate with the network 130-c through network communications module 605. Radio access network 550-c may be an example of an eNodeB base station, a Home eNodeB base station, a NodeB base station, a Radio Network Controller (RNC), and/or a Home NodeB base station.

Radio access network 550-c may also communicate with other base stations 105, such as base station 105-d and base station 105-e. Each of the base stations 105 may communicate with user equipment 115-g using different wireless communications technologies, such as different Radio Access Technologies. In some cases, radio access network 550-c may communicate with other base stations such as 105-d and/or 105-e utilizing base station communication module 620. In some embodiments, base station communication module 620 may provide an X2 interface within an LTE wireless communication technology to provide communication between some of the base stations 105. In some embodiments, radio access network 550-c may communicate with other base stations through a controller 120 (not shown) and/or network 130-c.

The memory 615 may include random access memory (RAM) and read-only memory (ROM). The memory 615 may also store computer-readable, computer-executable software code 616 containing instructions that are configured to, when executed, cause the processor module 610 to perform various functions described herein (e.g., call processing, database management, message routing, etc.). Alternatively, the software 616 may not be directly executable by the processor module 610 but be configured to cause the computer, e.g., when compiled and executed, to perform functions described herein.

The processor module 610 may include an intelligent hardware device, e.g., a central processing unit (CPU) such as those made by Intel® Corporation or AMD®, a microcontroller, an application-specific integrated circuit (ASIC), etc. The processor module 610 may include a speech encoder (not shown) configured to receive audio via a microphone, convert the audio into packets (e.g., 20 ms in length) representative of the received audio, provide the audio packets, and/or provide indications of whether a user is speaking.

The transceiver module 625 may include a modem configured to modulate the packets and provide the modulated packets to the antennas 630 for transmission, and to demodulate packets received from the antennas 630. While some examples of the radio access network 550-c may include a single antenna 630, the radio access network 550-c preferably includes multiple antennas 630 for multiple links which may support carrier aggregation. For example, one or more links may be used to support macro communications with user equipment 115-g.

According to the architecture of FIG. 6, the radio access network 550-c may further include a communications management module 640. The communications management module 640 may manage communications with other base stations 105 or controller 120 (not shown). By way of example, the communications management module 640 may be a component of the radio access network 550-c in communication with some or all of the other components of the radio access network 550-c via a bus. Alternatively, functionality of the communications management module 640 may be implemented as a component of the transceiver module 625, as a computer program product, and/or as one or more controller elements of the processor module 610.

The components for radio access network 550-c may be configured to implement aspects discussed above with respect to device 400-b of FIG. 4B and may not be repeated here for the sake of brevity. The flexible BW paging module (paging module) 410-c may be an example of the flexible BW paging module 410, 410-a, and/or 410-b. Paging module 410-c may be configured for reducing PICH collisions and for mitigating for reduced paging capacity generally including the techniques described above in reference to FIG. 4B.

The radio access network 500-c may also include a spectrum identification module 645. The spectrum identification module 645 may be utilized to identify spectrum available for flexible bandwidth waveforms. In some embodiments, a handover module 635 may be utilized to perform handover procedures of the user equipment 115-g from one base station 105 to another. For example, the handover module 635 may perform a handover procedure of the user equipment 115-g from radio access network 550-c to another where normal waveforms are utilized between the user equipment 115-g and one of the base stations 105 and flexible bandwidth waveforms are utilized between the user equipment 115 and another base station 105. A scaling module 650 may be utilized to scale and/or alter chip rates to generate flexible bandwidth waveforms.

In some embodiments, the transceiver module 625 in conjunction with antennas 630, along with other possible components of radio access network 550-c, may transmit and/or receive information regarding flexible bandwidth waveforms and/or scaling factors from the radio access network 550-c to the user equipment 115-g, to other base stations 105-d/105-e, or core network 130-c. In some embodiments, the transceiver module 625 in conjunction with antennas 630, along with other possible components of radio access network 550-c, may transmit and/or receive information to or from the user equipment 115-g, to or from other base stations 105-d/105-e, or core network 130-c, such as flexible bandwidth waveforms and/or scaling factors, such that these devices or systems may utilize flexible bandwidth waveforms.

FIG. 7 is a block diagram 700 of a user equipment 115-h configured for mitigating reduced paging capacity over flexible bandwidth carriers in accordance with various embodiments. The user equipment 115-h may have any of various configurations, such as personal computers (e.g., laptop computers, netbook computers, tablet computers, etc.), cellular telephones, PDAs, digital video recorders (DVRs), internet appliances, gaming consoles, e-readers, etc. The user equipment 115-h may have an internal power supply (not shown), such as a small battery, to facilitate mobile operation. In some embodiments, the user equipment 115-h may be the user equipment 115 of FIGS. 1, 2A, 2B, 3, 5, 6, and/or 8, the device 400-a of FIG. 4A, and/or the device 400-b of FIG. 4B. The user equipment 115-h may be a multi-mode user equipment. The user equipment 115-h may be referred to as a wireless communications device in some cases. User equipment 115-h may be configured to implement different aspects of the call flows and/or systems as shown in FIGS. 4A and 4B and/or associated descriptions.

The user equipment 115-h may include antennas 730, a transceiver module 725, memory 715, and a processor module 710, which each may be in communication, directly or indirectly, with each other (e.g., via one or more buses). The transceiver module 725 is configured to communicate bi-directionally, via the antennas 730 and/or one or more wired or wireless links, with one or more networks, as described above. For example, the transceiver module 725 may be configured to communicate bi-directionally with base stations 105 of FIGS. 1, 2A, 2B, 3, 6, and/or 8; or devices 400-a and 400-b of FIGS. 4A and 4B, FIGS; and/or the radio access networks 550 of FIGS. 5 and 6. The transceiver module 725 may include a modem configured to modulate the packets and provide the modulated packets to the antennas 730 for transmission, and to demodulate packets received from the antennas 730. While the user equipment 115-h may include a single antenna, the user equipment 115-h will typically include multiple antennas 730 for multiple links.

The memory 715 may include random access memory (RAM) and read-only memory (ROM). The memory 715 may store computer-readable, computer-executable software code 716 containing instructions that are configured to, when executed, cause the processor module 710 to perform various functions described herein (e.g., call processing, database management, message routing, etc.). Alternatively, the software 716 may not be directly executable by the processor module 710 but be configured to cause the computer (e.g., when compiled and executed) to perform functions described herein.

The processor module 710 may include an intelligent hardware device, e.g., a central processing unit (CPU) such as those made by Intel® Corporation or AMD®, a microcontroller, an application-specific integrated circuit (ASIC), etc. The processor module 710 may include a speech encoder (not shown) configured to receive audio via a microphone, convert the audio into packets (e.g., 20 ms in length) representative of the received audio, provide the audio packets to the transceiver module 725, and provide indications of whether a user is speaking. Alternatively, an encoder may only provide packets to the transceiver module 725, with the provision or withholding/suppression of the packet itself providing the indication of whether a user is speaking. The processor module 710 may also include a speech decoder that may perform a reverse functionality as the speech encoder.

According to the architecture of FIG. 7, the user equipment 115-h may further include a communications management module 740. The communications management module 740 may manage communications with other user equipment 115. By way of example, the communications management module 740 may be a component of the user equipment 115-h in communication with some or all of the other components of the user equipment 115-h via a bus. Alternatively, functionality of the communications management module 740 may be implemented as a component of the transceiver module 725, as a computer program product, and/or as one or more controller elements of the processor module 710.

The components for user equipment 115-h may be configured to implement aspects discussed above with respect to device 400-a and/or 400-b of FIGS. 4A and 4B and may not be repeated here for the sake of brevity. The paging module 720 may be configured to perform one or more paging reduction mitigation techniques for flexible bandwidth carriers, corresponding to paging module 410 and 410-a of FIGS. 4A and 4B.

The user equipment 115-h may also include a spectrum identification module 745. The spectrum identification module 745 may be utilized to identify spectrum available for flexible bandwidth waveforms. In some embodiments, a handover module 735 may be utilized to perform handover procedures of the user equipment 115-h from one base station to another. For example, the handover module 735 may perform a handover procedure of the user equipment 115-h from one base station to another where normal waveforms are utilized between the user equipment 115-h and one of the base stations and flexible bandwidth waveforms are utilized between the user equipment and another base station. A scaling module 750 may be utilized to scale and/or alter chip rates to generate/decode flexible bandwidth waveforms.

In some embodiments, the transceiver module 725, in conjunction with antennas 730, along with other possible components of user equipment 115-h, may transmit information regarding flexible bandwidth waveforms and/or scaling factors from the user equipment 115-h to base stations or a core network. In some embodiments, the transceiver module 725, in conjunction with antennas 730, along with other possible components of user equipment 115-h, may transmit/receive information, such flexible bandwidth waveforms and/or scaling factors, to/from base stations or a core network such that these devices or systems may utilize flexible bandwidth waveforms.

FIG. 8 is a block diagram of a system 800 including a base station 105-f and a user equipment 115-i in accordance with various embodiments. This system 800 may be an example of the systems or components of systems 100, 200-a, 200-b, 300, 400-a, 400-b, 500 600, and or 700 of FIGS. 1, 2A, 2B, 3, 4A, 4B, 5, 6, and 7. The base station 105-f may be equipped with antennas 834-a through 834-x, and the user equipment 115-i may be equipped with antennas 852-a through 852-n. At the base station 105-f, a transmit processor 820 may receive data from a data source. System 800 may be configured to implement different aspects of the call flows and/or systems as described in reference to FIGS. 4A and 4B for mitigating reduced paging capacity over flexible bandwidth carrier systems.

The transmit processor 820 may process the data. The transmit processor 820 may also generate reference symbols, and a cell-specific reference signal. A transmit (TX) MIMO processor 830 may perform spatial processing (e.g., precoding) on data symbols, control symbols, and/or reference symbols, if applicable, and may provide output symbol streams to the transmit modulators 832-a through 832-x. Each modulator 832 may process a respective output symbol stream (e.g., for OFDM, etc.) to obtain an output sample stream. Each modulator 832 may further process (e.g., convert to analog, amplify, filter, and upconvert) the output sample stream to obtain a downlink (DL) signal. In one example, DL signals from modulators 832-a through 832-x may be transmitted via the antennas 834-a through 834-x, respectively. The transmit processor 820 may receive information from a processor 840. The processor 840 may be coupled with a memory 842. The processor 840 may be configured to generate flexible bandwidth waveforms through altering a chip rate and/or utilizing a scaling factor. In some embodiments, the processor module 840 may be configured for dynamically adapting flexible bandwidth in accordance with various embodiments. The processor 840 may dynamically adjust one or more scale factors of the flexible bandwidth signal associated with transmissions between base station 105-f and user equipment 115-i. These adjustments may be made based on information such as traffic patterns, interference measurements, etc.

For example, within system 800, the processor 840 may configured for mitigating reduced paging capacity over flexible bandwidth carriers according to one or more of the various techniques described above in reference to FIG. 4B. For the sake of brevity, those techniques will not be repeated here.

At the user equipment 115-i, the user equipment antennas 852-a through 852-n may receive the DL signals from the base station 105-f and may provide the received signals to the demodulators 854-a through 854-n, respectively. Each demodulator 854 may condition (e.g., filter, amplify, downconvert, and digitize) a respective received signal to obtain input samples. Each demodulator 854 may further process the input samples (e.g., for OFDM, etc.) to obtain received symbols. A MIMO detector 856 may obtain received symbols from all the demodulators 854-a through 854-n, perform MIMO detection on the received symbols, if applicable, and provide detected symbols. A receive processor 858 may process (e.g., demodulate, deinterleave, and decode) the detected symbols, providing decoded data for the user equipment 115-i to a data output, and provide decoded control information to a processor 880, or memory 882.

On the uplink (UL) or reverse link, at the user equipment 115-i, a transmit processor 864 may receive and process data from a data source. The transmitter processor 864 may also generate reference symbols for a reference signal. The symbols from the transmit processor 864 may be precoded by a transmit MIMO processor 866, if applicable, further processed by the demodulators 854-a through 854-n (e.g., for SC-FDMA, etc.), and be transmitted to the base station 105-f in accordance with the transmission parameters received from the base station 105-f. The transmit processor 864 may also be configured to generate flexible bandwidth waveforms through altering a chip rate and/or utilizing a scaling factor; this may be done dynamically in some cases. The transmit processor 864 may receive information from processor 880. The processor 880 may provide for different alignment and/or offsetting procedures. The processor 880 may also utilize scaling and/or chip rate information to perform measurements on the other subsystems, perform handoffs to the other subsystems, perform reselection, etc. The processor 880 may invert the effects of time stretching associated with the use of flexible bandwidth through parameter scaling. At the base station 105-f, the UL signals from the user equipment 115-i may be received by the antennas 834, processed by the demodulators 832, detected by a MIMO detector 836, if applicable, and further processed by a receive processor 838. The receive processor 838 may provide decoded data to a data output and to the processor 840. In some embodiments, the processor 840 may be implemented as part of a general processor, the transmit processor 820, and/or the receiver processor 838.

In some embodiments, the processor module 880 may be configured for dynamically adapting flexible bandwidth in accordance with various embodiments. The processor 880 may dynamically adjust one or more scale factors of the flexible bandwidth signal associated with transmissions between base station 105-f and user equipment 115-i. These adjustments may be made based on information such as traffic patterns, interference measurements, etc.

For example, within system 4200, the processor 880 may configured for mitigating reduced paging capacity over flexible bandwidth carriers according to one or more of the various techniques described above in reference to FIG. 4B. For the sake of brevity, those techniques will not be repeated here.

Turning to FIG. 9A, a flow diagram of a method 900-a for supporting paging over a flexible bandwidth carrier within wireless communications systems is provided in accordance with various embodiments. Method 900-a may be implemented utilizing various wireless communications devices and/or systems and or components of systems 100, 200-a, 200-b, 300, 400-a, 400-b, 500, 600, 700, and/or 800 of FIGS. 1, 2A, 2B, 3, 4A, 4B, 5, 6, 7, and 8.

At block 905, a reduced capacity for a flexible bandwidth carrier with respect to a target paging capacity may be identified. At block 910, the reduced paging capacity for the flexible bandwidth carrier may be mitigated. In some cases, the target paging capacity may be a paging capacity for a normal bandwidth carrier system. In some cases, the target paging capacity may be a paging capacity for another flexible bandwidth carrier.

In some embodiments, mitigating for the reduced paging capacity for the flexible bandwidth carrier includes increasing a number of paging indicators per frame over the flexible bandwidth carrier to mitigate for the reduced paging capacity for the flexible bandwidth carrier. Mitigating for the reduced paging capacity for the flexible bandwidth carrier may include reducing a spreading factor for a physical channel carrying one or more paging indicators over the flexible bandwidth carrier to mitigate for the reduced paging capacity for the flexible bandwidth carrier. Reducing the spreading factor may include reducing the spreading factor for the physical channel by at least a bandwidth scaling factor (e.g., N) of the flexible bandwidth carrier or a fraction of the bandwidth scaling factor (e.g., N/2) of the flexible bandwidth carrier. Some embodiments further include increasing a transmission power for the physical channel over the flexible bandwidth carrier with respect to a normal bandwidth carrier system having a same power spectrum density.

In some embodiments, mitigating for the reduced paging capacity for the flexible bandwidth carrier includes reducing a spreading factor for a secondary common control physical channel (SCCPCH) carrying one or more paging indicators over the flexible bandwidth carrier to mitigate for the reduced paging capacity for the flexible bandwidth carrier. Reducing the spreading factor may include reducing the spreading factor for the (SCCPCH) by at least a bandwidth scaling factor (e.g., N) of the flexible bandwidth carrier or a fraction of the bandwidth scaling factor (e.g., N/2) of the flexible bandwidth carrier. Some embodiments further include increasing a transmission power for the SCCPCH over the flexible bandwidth carrier with respect to a normal bandwidth carrier system having a same power spectrum density.

Mitigating for the reduced paging capacity for the flexible bandwidth carrier may include utilizing a plurality of paging channels to mitigate for the reduced paging capacity for the flexible bandwidth carrier. The plurality of paging channels may include at least a plurality of PICHs or a plurality of SCCPCHs.

Mitigating for the reduced paging capacity for the flexible bandwidth carrier may include reducing a paging area. The paging area may be for at least the flexible bandwidth carrier and a normal bandwidth carrier. For example, a flexible bandwidth carrier and a normal bandwidth carrier may have separate paging areas. In some cases, there may be different paging areas for different carriers with the same bandwidth. Mitigating for the reduced paging capacity for the flexible bandwidth carrier may include utilizing at least a separate Location Area (LA) and/or Routing Area (RA) for the flexible bandwidth carrier with respect to at least a normal bandwidth carrier or another flexible bandwidth carrier. In some cases, the LA and RA may not overlap. In some cases, two carriers, such as a flexible bandwidth carrier with N=2 and a normal bandwidth carrier with N=1, may share the same LA and RA, while another flexible bandwidth carrier, such as with N=4, may have a separate LA/RA. Mitigating for the reduced paging capacity for the flexible bandwidth carrier may include registering at least one of the flexible bandwidth carriers separately at a core network.

In some embodiments, block 910 may be performed by flexible BW paging module 410, 410-a, 410-b, and/or 410-c of FIGS. 4A, 4B, 5, and 6, and/or by paging module 720 of FIG. 7.

Turning to FIG. 9B, a flow diagram of a method 900-b for supporting paging over a flexible bandwidth carrier within wireless communications systems is provided in accordance with various embodiments. Method 900-b may be implemented utilizing various wireless communications devices and/or systems and or components of systems 100, 200-a, 200-b, 300, 400-a, 400-b, 500, 600, 700, and/or 800 of FIGS. 1, 2A, 2B, 3, 4A, 4B, 5, 6, 7, and 8. Method 900-b may be an example of one or more aspects of method 900-a of FIG. 9A.

At block 905-a, a reduced capacity with respect to a target paging capacity for a flexible bandwidth carrier may be identified. At block 915, a spreading factor for a physical channel over the flexible bandwidth carrier may be reduced. In some embodiments, at block 920, a transmission power for the physical channel over the flexible bandwidth carrier may be increased with respect to a normal bandwidth carrier system having a same or similar power spectrum density.

In some embodiments, block 910-a, as similarly described in reference to FIG. 9A, may include blocks 915 and 920. In some embodiments, blocks 915 and 920, or block 910-a may be performed by Flexible BW Paging module 410, 410-a, 410-b, and/or 410-c of FIGS. 4A, 4B, 5, and 6, and/or by paging module 720 of FIG. 7.

Turning to FIG. 9C, a flow diagram of a method 900-c for supporting paging over a flexible bandwidth carrier within wireless communications systems is provided in accordance with various embodiments. Method 900-c may be implemented utilizing various wireless communications devices and/or systems and or components of systems 100, 200-a, 200-b, 300, 400-a, 400-b, 500, 600, 700, and/or 800 of FIGS. 1, 2A, 2B, 3, 4A, 4B, 5, 6, 7, and 8. Method 900-c may be an example of one or more aspects of method 900-a of FIG. 9A and/or method 900-b of FIG. 9B.

At block 905-b, a reduced capacity with respect to a target paging capacity for a flexible bandwidth carrier may be identified. At block 925, a spreading factor for a SCCPCH over the flexible bandwidth carrier may be reduced. In some embodiments, at block 930, a transmission power for the SCCPCH over the flexible bandwidth carrier may be increased with respect to a normal bandwidth carrier system having a same or similar power spectrum density.

In some embodiments, block 910-b, as similarly described in reference to FIGS. 9A and 9B, may include blocks 925 and 930. In some embodiments, blocks 925 and 930, or block 910-b may be performed by Flexible BW Paging module 410, 410-a, 410-b, and/or 410-c of FIGS. 4A, 4B, 5, and 6, and/or by paging module 720 of FIG. 7.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general-purpose or special-purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for supporting paging over a flexible bandwidth carrier, the method comprising:
identifying a reduced paging capacity with respect to a target paging capacity for the flexible bandwidth carrier; and
mitigating for the reduced paging capacity for the flexible bandwidth carrier.

2. The method of claim 1, wherein mitigating for the reduced paging capacity for the flexible bandwidth carrier comprises:
increasing a number of paging indicators per frame over the flexible bandwidth carrier to mitigate for the reduced paging capacity for the flexible bandwidth carrier.

3. The method of claim 1, wherein mitigating for the reduced paging capacity for the flexible bandwidth carrier comprises:
reducing a spreading factor for a physical channel carrying one or more paging indicators over the flexible bandwidth carrier to mitigate for the reduced paging capacity for the flexible bandwidth carrier.

4. The method of claim 3, wherein reducing the spreading factor comprises reducing the spreading factor for the physical channel by at least a bandwidth scaling factor of the flexible bandwidth carrier or a fraction of the bandwidth scaling factor of the flexible bandwidth carrier.

5. The method of claim 3, further comprising:
increasing a transmission power for the physical channel over the flexible bandwidth carrier with respect to a normal bandwidth carrier system having a same power spectrum density.

6. The method of claim 1, wherein mitigating for the reduced paging capacity for the flexible bandwidth carrier comprises:
reducing a spreading factor for a secondary common control physical channel (SCCPCH) carrying one or more paging indicators over the flexible bandwidth carrier to mitigate for the reduced paging capacity for the flexible bandwidth carrier.

7. The method of claim 6, further comprising:
increasing a transmission power for the SCCPCH over the flexible bandwidth carrier with respect to a normal bandwidth carrier system having a same power spectrum density.

8. The method of claim 1, wherein mitigating for the reduced paging capacity for the flexible bandwidth carrier comprises:
utilizing a plurality of paging channels to mitigate for the reduced paging capacity for the flexible bandwidth carrier.

9. The method of claim 8, wherein the plurality of paging channels comprises at least a plurality of PICHs or a plurality of SCCPCHs.

10. The method of claim 1, wherein mitigating for the reduced paging capacity for the flexible bandwidth carrier comprises:
reducing a paging area.

11. The method of claim 10, wherein the paging area is for at least the flexible bandwidth carrier and a normal bandwidth carrier.

12. The method of claim 1, wherein mitigating for the reduced paging capacity for the flexible bandwidth carrier comprises:
utilizing at least a separate Location Area (LA) or a separate Routing Area (RA) for the flexible bandwidth carrier with respect to at least a normal bandwidth carrier or another flexible bandwidth carrier.

13. The method of claim 1, wherein mitigating for the reduced paging capacity for the flexible bandwidth carrier comprises:
registering at least one of the flexible bandwidth carriers separately at a core network.

14. The method of claim 1, wherein the target paging capacity comprises a paging capacity of a normal bandwidth carrier system.

15. The method of claim 1, wherein the target paging capacity comprises a paging capacity of another flexible bandwidth carrier.

16. A wireless communications system for supporting paging over a flexible bandwidth carrier, the system comprising:
means for identifying a reduced paging capacity with respect to a target paging capacity for the flexible bandwidth carrier; and
means for mitigating for the reduced paging capacity for the flexible bandwidth carrier.

17. The wireless communications system of claim 16, wherein the means for mitigating for the reduced paging capacity for the flexible bandwidth carrier comprises:
means for increasing a number of paging indicators per frame over the flexible bandwidth carrier to mitigate for the reduced paging capacity for the flexible bandwidth carrier.

18. The wireless communications system of claim 16, wherein the means for mitigating for the reduced paging capacity for the flexible bandwidth carrier comprises:
means for reducing a spreading factor for a physical channel carrying one or more paging indicators over the flexible bandwidth carrier to mitigate for the reduced paging capacity for the flexible bandwidth carrier.

19. The wireless communications system of claim 18, wherein reducing the spreading factor comprises reducing the spreading factor for the physical channel by at least a bandwidth scaling factor of the flexible bandwidth carrier or a fraction of the bandwidth scaling factor of the flexible bandwidth carrier.

20. The wireless communications system of claim 18, wherein the means for mitigating for the reduced paging capacity for the flexible bandwidth carrier comprises:
means for increasing a transmission power for the physical channel over the flexible bandwidth carrier with respect to a normal bandwidth carrier system having a same power spectrum density.

21. The wireless communications system of claim 16, wherein the means for mitigating for the reduced paging capacity for the flexible bandwidth carrier comprises:
means for reducing a spreading factor for a secondary common control physical channel (SCCPCH) carrying one or more paging indicators over the flexible bandwidth carrier to mitigate for the reduced paging capacity for the flexible bandwidth carrier.

22. The wireless communications system of claim 21, further comprising:
means for increasing a transmission power for the SCCPCH over the flexible bandwidth carrier with respect to a normal bandwidth carrier system having a same power spectrum density.

23. The wireless communications system of claim 16, wherein the means for mitigating for the reduced paging capacity for the flexible bandwidth carrier comprises:
means for utilizing a plurality of paging channels to mitigate for the reduced paging capacity for the flexible bandwidth carrier.

24. The wireless communications system of claim 23, wherein the plurality of paging channels comprises at least a plurality of PICHs or a plurality of SCCPCHs.

25. The wireless communications system of claim 16, wherein the means for mitigating for the reduced paging capacity for the flexible bandwidth carrier comprises:
means for reducing a paging area.

26. The wireless communications system of claim 25, wherein the paging area is for at least the flexible bandwidth carrier and a normal bandwidth carrier.

27. The wireless communications system of claim 16, wherein the means for mitigating for the reduced paging capacity for the flexible bandwidth carrier comprises:
means for utilizing at least a separate Location Area (LA) or a separate Routing Area (RA) for the flexible bandwidth carrier with respect to at least a normal bandwidth carrier or another flexible bandwidth carrier.

28. The wireless communications system of claim 16, wherein the means for mitigating for the reduced paging capacity for the flexible bandwidth carrier comprises:
means for registering at least one of the flexible bandwidth carriers separately at a core network.

29. The wireless communications system of claim 16, wherein the target paging capacity comprises a paging capacity of a normal bandwidth carrier system.

30. The wireless communications system of claim 16, wherein the target paging capacity comprises a paging capacity of another flexible bandwidth carrier.

31. A computer program product for supporting paging over a flexible bandwidth carrier comprising:
a non-transitory computer-readable medium comprising:
code for identifying a reduced paging capacity with respect to a target paging capacity for the flexible bandwidth carrier; and
code for mitigating for the reduced paging capacity for the flexible bandwidth carrier.

32. The computer program product of claim 31, wherein the code for mitigating for the reduced paging capacity for the flexible bandwidth carrier comprises:
code for increasing a number of paging indicators per frame over the flexible bandwidth carrier to mitigate for the reduced paging capacity for the flexible bandwidth carrier.

33. The computer program product of claim 31, wherein the code for mitigating for the reduced paging capacity for the flexible bandwidth carrier comprises:
code for reducing a spreading factor for a physical channel carrying one or more paging indicators over the flexible bandwidth carrier to mitigate for the reduced paging capacity for the flexible bandwidth carrier.

34. The computer program product of claim 33, wherein the code for reducing the spreading factor comprises code for reducing the spreading factor for the physical channel by at least a bandwidth scaling factor of the flexible bandwidth carrier or a fraction of the bandwidth scaling factor of the flexible bandwidth carrier.

35. The computer program product of claim 33, further comprising:
code for increasing a transmission power for the physical channel over the flexible bandwidth carrier with respect to a normal bandwidth carrier system having a same power spectrum density.

36. The computer program product of claim 31, wherein the code for mitigating for the reduced paging capacity for the flexible bandwidth carrier comprises:
code for reducing a spreading factor for a secondary common control physical channel (SCCPCH) carrying one or more paging indicators over the flexible bandwidth carrier to mitigate for the reduced paging capacity for the flexible bandwidth carrier.

37. The computer program product of claim 36, further comprising:
code for increasing a transmission power for the SCCPCH over the flexible bandwidth carrier with respect to a normal bandwidth carrier system having a same power spectrum density.

38. The computer program product of claim 31, wherein the code for mitigating for the reduced paging capacity for the flexible bandwidth carrier comprises:
code for utilizing a plurality of paging channels to mitigate for the reduced paging capacity for the flexible bandwidth carrier.

39. The computer program product of claim 38, wherein the plurality of paging channels comprises at least a plurality of PICHs or a plurality of SCCPCHs.

40. The computer program product of claim 31, wherein the code for mitigating for the reduced paging capacity for the flexible bandwidth carrier comprises:
code for reducing a paging area.

41. The computer program product of claim 40, wherein the paging area is for at least the flexible bandwidth carrier and a normal bandwidth carrier.

42. The computer program product of claim 31, wherein the code for mitigating for the reduced paging capacity for the flexible bandwidth carrier comprises:
code for utilizing at least a separate Location Area (LA) or a separate Routing Area (RA) for the flexible bandwidth carrier with respect to at least a normal bandwidth carrier or another flexible bandwidth carrier.

43. The computer program product of claim 31, wherein the code for mitigating for the reduced paging capacity for the flexible bandwidth carrier comprises:
code for registering at least one of the flexible bandwidth carriers separately at a core network.

44. The computer program product of claim 31, wherein the target paging capacity comprises a paging capacity of a normal bandwidth carrier system.

45. The computer program product of claim 31, wherein the target paging capacity comprises a paging capacity of another flexible bandwidth carrier.

46. A wireless communications device configured for supporting paging over a flexible bandwidth carrier, the device comprising:
at least one processor configured to:
identify a reduced paging capacity with respect to a target paging capacity for the flexible bandwidth carrier; and
mitigate for the reduced paging capacity for the flexible bandwidth carrier.

47. The wireless communications device of claim 46, wherein the at least one processor configured to mitigate for the reduced paging capacity for the flexible bandwidth carrier is configured to:
increase a number of paging indicators per frame over the flexible bandwidth carrier to mitigate for the reduced paging capacity for the flexible bandwidth carrier.

48. The wireless communications device of claim 46, wherein the at least one processor configured to mitigate for the reduced paging capacity for the flexible bandwidth carrier is configured to:
reduce a spreading factor for a physical channel carrying one or more paging indicators over the flexible bandwidth carrier to mitigate for the reduced paging capacity for the flexible bandwidth carrier.

49. The wireless communications device of claim 48, wherein reducing the spreading factor comprises reducing the spreading factor for the physical channel by at least a bandwidth scaling factor of the flexible bandwidth carrier or a fraction of the bandwidth scaling factor of the flexible bandwidth carrier.

50. The wireless communications device of claim 48, wherein the at least one processor is further configured to:
increase a transmission power for the physical channel over the flexible bandwidth carrier with respect to a normal bandwidth carrier system having a same power spectrum density.

51. The wireless communications device of claim 46, wherein the at least one processor configured to mitigate for the reduced paging capacity for the flexible bandwidth carrier is configured to:
reduce a spreading factor for a secondary common control physical channel (SCCPCH) carrying one or more paging indicators over the flexible bandwidth carrier to mitigate for the reduced paging capacity for the flexible bandwidth carrier.

52. The wireless communications device of claim 51, wherein the at least one processor is further configured to:
increase a transmission power for the SCCPCH over the flexible bandwidth carrier with respect to a normal bandwidth carrier system having a same power spectrum density.

53. The wireless communications device of claim 46, wherein the at least one processor configured to mitigate for the reduced paging capacity for the flexible bandwidth carrier is configured to:
utilize a plurality of paging channels to mitigate for the reduced paging capacity for the flexible bandwidth carrier.

54. The wireless communications device of claim 53, wherein the plurality of paging channels comprises at least a plurality of PICHs or a plurality of SCCPCHs.

55. The wireless communications device of claim 46, wherein the at least one processor configured to mitigate for the reduced paging capacity for the flexible bandwidth carrier is configured to:
reduce a paging area.

56. The wireless communications device of claim 55, wherein the paging area is for at least the flexible bandwidth carrier and a normal bandwidth carrier.

57. The wireless communications device of claim 46, wherein the at least one processor configured to mitigate for the reduced paging capacity for the flexible bandwidth carrier is configured to:
utilize at least a separate Location Area (LA) or a separate Routing Area (RA) for the flexible bandwidth carrier with respect to at least a normal bandwidth carrier or another flexible bandwidth carrier.

58. The wireless communications device of claim 46, wherein the at least one processor configured to mitigate for the reduced paging capacity for the flexible bandwidth carrier is configured to:
register at least one of the flexible bandwidth carriers separately at a core network.

59. The wireless communications device of claim 46, wherein the target paging capacity comprises a paging capacity of a normal bandwidth carrier system.

60. The wireless communications device of claim 46, wherein the target paging capacity comprises a paging capacity of another flexible bandwidth carrier.
